(19) United States
(12) Patent Application Publication
(10) Pub. No.: US 2006/0015939 A1
(43) Pub. Date: Jan. 19, 2006

(54) METHOD AND SYSTEM TO PROTECT A FILE SYSTEM FROM VIRAL INFECTIONS

(75) Inventors: James E. Aston, Morrisville, NC (US); Haley L. Gray, Cary, NC (US); Durga D. Mannaru, Raleigh, NC (US)

Correspondence Address: MOORE & VAN ALLEN, PLLC, P.O. Box 13706, Research Triangle Park, NC, 27709, US

(73) Assignee: INTERNATIONAL BUSINESS MACHINES CORPORATION, Armonk, NY (US)

(21) Appl. No.: 10/710,477

(22) Filed: Jul. 14, 2004

(51) Int. Cl. G06F 11/00

(52) U.S. Cl. 726/22

(57) ABSTRACT

A method to protect a file system form a viral infection may include flagging the program in response to opening a local file on a local file system to perform a read operation and opening a shared file on shared or network file system to perform a write or append operation on the local file. The program may also be flagged in response to the program reading or opening itself and the program attempting to write or append itself or any content to the shared file on the shared or network file system or to write or append itself or any content to the local file on the local file system. The program may also be flagged in response to the program attempting to write or append the local file to the shared or network file system and to preserve a filename of the local file in the shared or network file system. The program may also be flagged in response to the program attempting to write or append a remote file to the local file system.

### BACKGROUND OF INVENTION

The present invention relates to electronic or computer file systems and more particularly to a method and system to protect a file system from viral infections.

Currently, a personal computer, workstation or the like may be infected by a virus simply by being connected to a remote, shared or network file system or disk that is infected. A personal computer, workstation or the like that is infected may also infect the remote, shared or network file system or disk. This may be possible even if the latest virus protection software and patches are downloaded regularly because viruses can infect thousands of computers before the virus is detected or a fix becomes available. Computer systems are particularly vulnerable between the outbreak of a new virus and the release of the anti-virus software to detect and deal with the virus.

### SUMMARY OF INVENTION

In accordance with an embodiment of the present invention, a method to protect a file system from a viral infection may include flagging a program in response to at least one of: opening a local file on a local file system to perform a read operation and opening a shared file on a shared or network file system to perform a write or append operation with the local file; the program reading or opening itself and the program attempting to write or append itself or any content to the shared file on the shared or network file system or to write or append itself or any content to the local file on the local file system; the program attempting to write or append the local file to the shared or network file system and preserve a filename of the local file in the shared or network file system; and the program attempting to write or append a remote file to the local file system.

In accordance with another embodiment of the present invention, a method to protect a file system form a viral infection may include monitoring predetermined file system operations associated with a program. The method may also include logging any predetermined file system operations associated with the program including recording a filename and a location where the file is written.

In accordance with another embodiment of the present invention, a system to protect a file system form a viral infection may include a file system protection program that may include means to monitor predetermined file system operations associated with another program. The file system protection program may also include means to log any predetermined file system operations associated with the other program including recording a filename and a location where a file is written.

In accordance with another embodiment of the present invention, a method of making a system to protect a file system from a viral infection may include providing a file system protection program. Providing the file system protection program may include providing means to monitor predetermined file system operations associated with another program. Providing the file system protection program may also include providing means to log any predetermined file system operations associated with the other program including recording a filename and a location where a file is written.

In accordance with another embodiment of the present invention, a computer readable medium having computer-executable instructions for performing a method that may include monitoring predetermined file system operations associated with the program. The method may also include logging any predetermined file system operations associated with the program including recording a filename and a location where a file in written.

### BRIEF DESCRIPTION OF DRAWINGS

FIGS. 1A-1H (collectively FIG. 1) is a flow chart of an exemplary method to protect a file system from viral infections in accordance with an embodiment of the present invention.

FIG. 2 is a block schematic diagram of an exemplary system to protect a file system from a viral infection in accordance with an embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

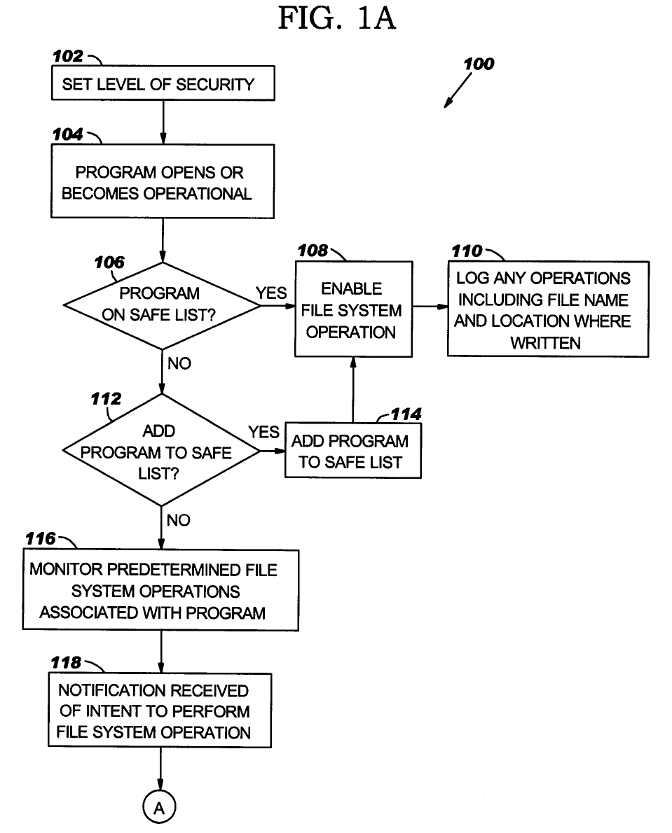

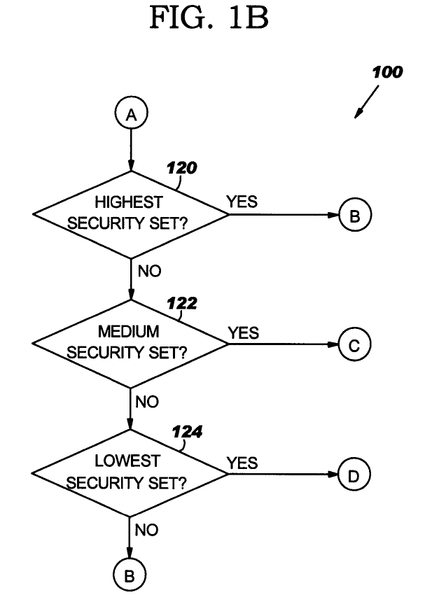

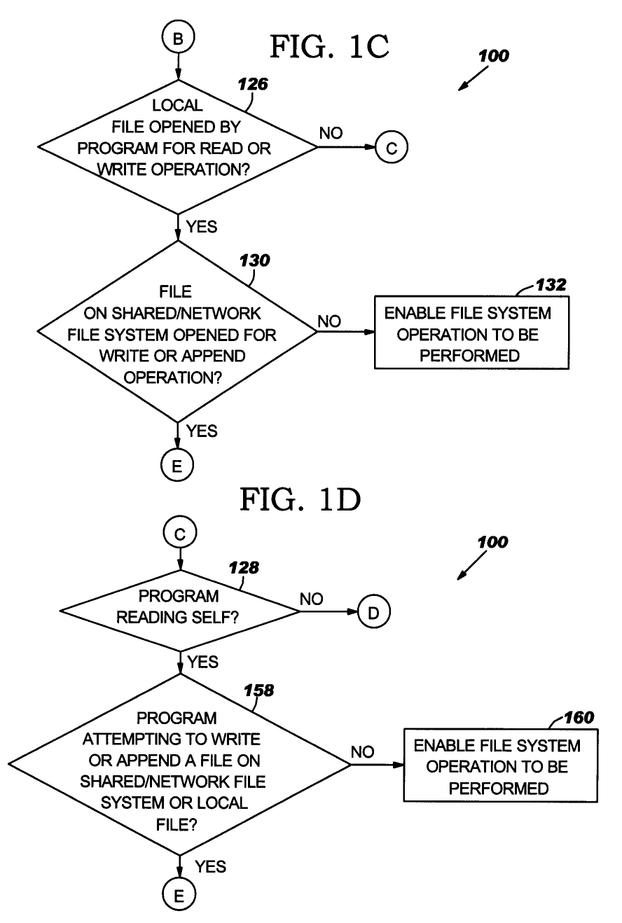

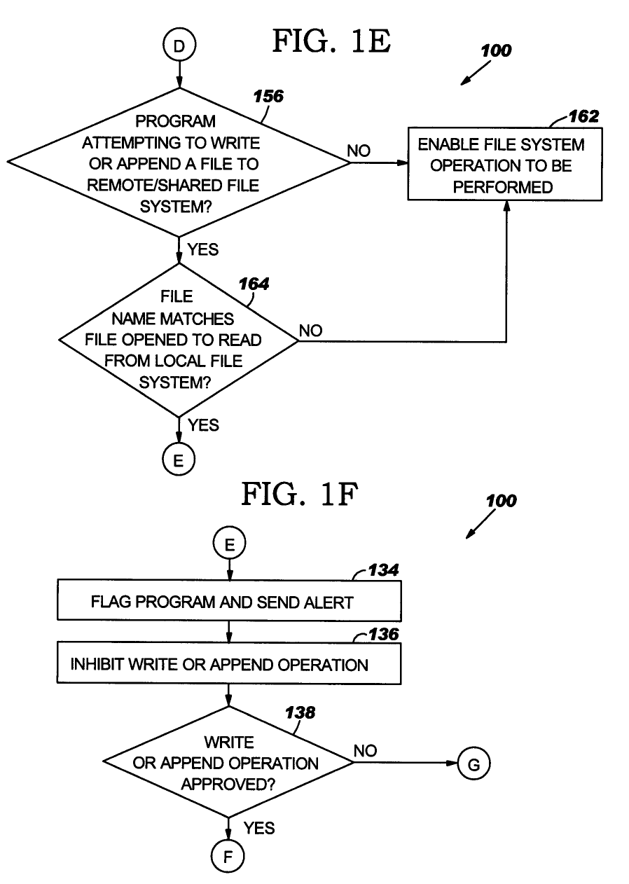

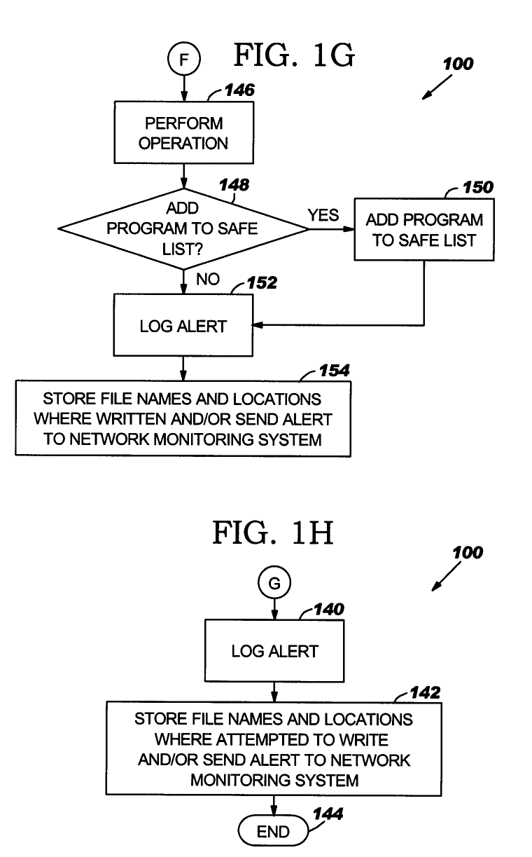

FIGS. 1A-1H (collectively FIG. 1) is a flow chart of an exemplary method 100 to protect a file system from viral infections in accordance with an embodiment of the present invention. In block 102 a level of security may be set. As will be discussed in more detail herein, a highest security level, a medium security level or a lowest security level may be set. A predefined procedure may be followed to protect a file system from viral infections, as discussed herein, in response to each security level that may be set by a user. In block 104, a software program, file or the like may be opened or become operational. The program may open because a user intentionally opens the program by clicking on it using a computer pointing device or the like, or the program may open automatically because of other programs operating on a user's computer system or network to which the user's computer system is communicating. In block 106, a determination may be made if the program is on a “safe list.” The safe list may be a group of programs or files that are known to be highly secure against virus infection or intrusion and therefore are safe to access and run or execute. The safe list may be a list of safe programs or files pre-loaded into a system, file system protection program, or available on a network that can be accessed by the method 100. A user or administrator may be authorized to maintain the safe list and update the list periodically. Alternatively, a new safe list may be downloaded by a user from time-to-time or when notified of an updated safe list.

If the program or file is on the safe list, the method 100 may advance to block 108. In block 108, a file system operation that the program is attempting to perform may be enabled or authorized. In block 110, any file system operations that may be performed may be logged or recorded in a data storage system or device associated with a user's computer system or on a network to which the user's system is linked. Logging the file system operations provides an electronic paper trail to find any infected systems or machines and to assist in troubleshooting. The file system operation may be logged by recording a filename of the file and a memory or file location where the file is written. Logging the file system operations may also include recording any other information related to operations performed on the file or using the file that may be helpful in later identifying infected machines or systems, analyzing a virus, removing the virus and repairing any damage caused by the virus. For example, the file may be a local file that is opened or read by the program and that the program may attempt to write or append to another file in a remote, shared or network file system. Alternatively, the file may be a file on the remote, share, or network file system that the program is attempting to write or append to a local file on the local file system.

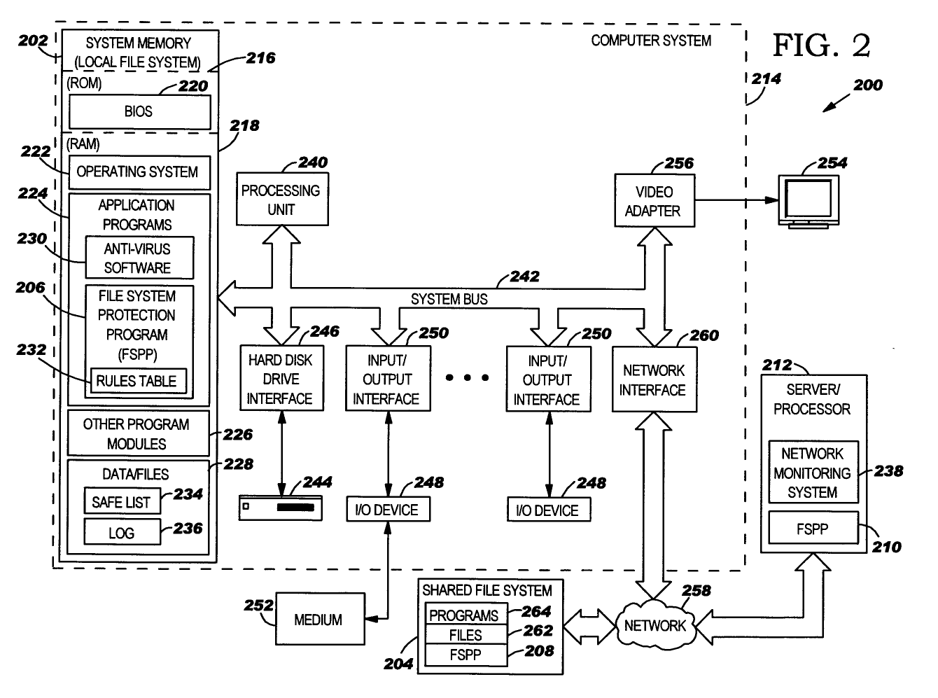

If the program is not a program on the safe list in block 106, the method 100 may advance to decision block 112. In block 112, an administrator or user may be asked if the program should be added to the safe list. If the user responds affirmatively in block 112, the program may be added to the safe list in block 114 and the method 100 will advance to blocks 108 and 110 similar to that previously described. If the user indicates in block 112 not to add the program to the safe list, the method 100 may advance to block 116. In an alternate embodiment of the present invention, the method 100 may advance from block 106 directly to block 116 without providing the option of adding the program to the safe list in blocks 112 and 114. In block 116, predetermined file system operations associated with the program of concern may be monitored. The predetermined file system operations may include opening a file, reading a file, writing a file to another file or appending the file to another file. Typical operations of concern may be reading or opening a local file on a local system and then attempting to write or append the file to another or remote file on a remote, shared or network file system. Also of concern are reading or opening a remote file in a remote, shared or network file system and attempting to write or append the file to a local file in a local file system. Some file system operations, such as selected read and write operations may be permitted based on predefined rules that may be stored and maintained in a rules table as discussed with respect to FIG. 2. While the present invention is being described with respect to read, write and append file system operations, the present invention may be applicable to any file system operations.

In block 118, a notification may be received from monitoring the predetermined file system operations of intent by the program to perform one of the predetermined file system operations. In blocks 120-124 (FIG. 1B), a determination may be made of the level of security set in block 102. In block 120, if a highest security level is set, the method 100 may advance to block 126. In block 126, a determination may be made if a file on a local file system was opened by the program for a read or write operation. If the determination is no, the method 100 may advance to block 128 in FIG. 1D. If the response in block 126 is yes, the method 100 may advance to block 130 (FIG. 1C). In block 130, a determination may be made if a remote or shared file on a remote, shared or network file system was opened by the program for a write or append operation. If the remote or shared file in block 130 was not opened for purposes of a write or append operation, the method 100 may advance to block 132. In block 132, the file system operation (write or append) may be enabled. If the remote or shared file in block 130 was opened by the program for purposes of a write or append operation, the method 100 may advance to block 134 in FIG. 1F. In block 134, the program may be flagged or identified as being suspect for possibly containing a virus. In block 134, an alert signal, warning message or the like may also be sent to a user. The alert or warning message or signal may identify the program and the file system operation the program is attempting to perform. The alert or warning message may also indicate that the program is not on the safe list and therefore may be suspect as possibly containing a virus and that performing the intended file system operation could infect the file system or files in the file system where the source file is being written or appended by the program. The alert or warning message may also ask a user if he wants to approve or authorize the file system operation.

In block 136, the write or append file system operation may be inhibited. As previously discussed, some file system operations may be permitted, such as selected read and write operations, based on predefined rules that may be stored and maintained in a rules table as discussed herein with reference to FIG. 2. In block 138, a determination may be made if the write or append operation was approved by the user. If the write or append operation was not approved, the method 100 may advance to block 140 in FIG. 1H. In block 140, the alert may be logged. In block 142, logging the alert may include storing or recording a file name, a file or memory location where the program was attempting to write or append the file. Logging the alert may also include recording an identity of the program and any other information that may be useful later for analysis in identifying a virus, removing the virus and repairing any damage caused by the virus. The recorded or stored information related to the alert and file system operation may be stored in a memory system associated with a local file system or remote file system as described with respect to FIG. 2. The alert and logged information may also be sent to a network monitoring system or the like for detailed analysis, as described with respect to FIG. 2. The method 100 may end at termination 144.

Returning to block 138 in FIG. 1F, if the file system operation or write or append operation is approved in block 138 by the user or another, the method 100 may advance block 146 in FIG. 1G. In block 146, the file system operation may be performed by the program. In block 148, the user may be asked by the method 100 if the program is to be added to the safe list. If the response is affirmative in block 148, the program may be added to the safe list in block 150. If the response in block 148 is that the program not be added to the safe list, the method 100 may advance to block 152. In block 152 the alert may be logged. In block 154, the alert may be logged by storing a file name, a file or memory location where the file is written or sent by the program in question. An identification of the program in question and any other information that may be useful in later analysis, removal or repair of the infected file may be recorded or stored in a system memory or the like as described with respect to FIG. 2. The alert and other information logged with respect to the file system operation may also be sent to a network monitoring system as described with respect to FIG. 2.

Returning to block 120 in FIG. 1B, if a highest security level or setting was not set in block 102 (FIG. 1A); the method 100 may advance to block 122. In block 122 a determination may be made if a medium level of security was set in block 102. If a medium level or setting of security was set, the method 100 may advance to block 128 in FIG. 1D. In block 128, a determination may be made whether the program in question is reading itself or attempting to open itself. If the program is not attempting to read or open itself, the method 100 may advance to block 156 in FIG. 1E. If the program is attempting to read or open itself in block 128 (FIG. 1D), the method 100 may advance to block 158 in FIG. 1D. In block 158, a determination may be made whether the program in question is attempting to write or append a local file from a local file system or any content on a remote or shared file or file system, or the converse, if the program is attempting to write or append a remote or shared file or any content on a local file or file system. If the response in block 158 is negative, the file system operation may be performed in block 160. If the response in block 158 is yes, the method 100 may advance to block 134 in FIG. 1F and the method 100 may proceed as previously discussed.

Returning to block 122 in FIG. 1B, if the medium level or setting is not set, the method 100 may advanced to block 124. In block 124, a determination may be made if the lowest security setting or level was set in block 102. If a determination is made that the lowest security setting or level was not set in block 102, the method 100 may advance to block 126 in FIG. 1C and the method 100 may proceed as previously described. If a determination is made in block 124 that the lowest security setting or level was set in block 102 (FIG. 1A), the method 100 may advance to block 156 in FIG. 1E. In block 156, a determination may be made if the program in question is attempting to write or append a file to the remote, shared or network file system. If the response in block 156 is no, the file system operation may be enabled to perform the operation in block 162. If the response in block 156 is yes, the method 100 may advance to block 164. In block 164, a determination may be made if a file name matches the file opened by the program to read from a local file system and to write to a remote, shared or network file system. In other words, a determination may be made if the program in question is attempting to copy a local file to a remote file system and preserve the file name. Alternatively, a determination may be made if the program is attempting to copy a remote file to a local file system and preserve the file name. If the response in block 164 is no, the file system operation may be enabled for performance in block 162. If the response in block 164 is yes, the method 100 may advance to block 134 (FIG. 1F) where the program may be flagged and an alert sent. The method 100 may then proceed as previously described with respect to FIG. 1F.

In summary, the method 100 may monitor all file system operations associated with any programs that are not on a safe list (blocks 106-116 of FIG. 1A). For the highest security setting or level, a monitored program may be flagged in response to opening a local file to read and also opening a file on a remote, shared or network file system for a write or append operation (portions of method 100 in FIGS. 1C and 1F). This portion of the method 100 may identify and protect against viruses that spread code from a local file system by either appending to files, such as a virus that spreads a malicious Microsoft Word macro or the like, or by writing new files to a remote system or vise versa. Most viruses copy an .exe file to the Startup folder or to a C:\WINNT\System32 folder. The method 100 can also catch all programs (probable viruses) that in their lifetime read a local file and also attempt to do a remote file write or append. This portion of the method 100 may also identify and protect against all viruses that are identified by those portions of the method 100 associated with the medium and lowest security levels or settings.

For the medium security level or setting as discussed above, a monitored program may be flagged in response to reading itself, such as for example, xxx.exe opens xxx.exe, and the monitored program also attempting to write or append a file on a remote, shared or network file system (portion of method 100 in FIGS. 1D and 1F). This portion of the method 100 catches all programs (probable viruses) that try to copy themselves over a network. This portion of the method 100 will also identify the class of polymorphic viruses that modify themselves slightly with each spread or propagation of the virus from one system to another. This portion of the method 100 may also identify and protect against all viruses that are identified by that portion of the method 100 associated with the lowest security level or setting.

For the lowest security level or setting as discussed, a monitored program may be flagged if the monitored program is written or appended to a file in a remote, shared or network file system and the file name matches the file opened by the monitored program to be read from a local file system (portion of method 100 in FIGS. 1E and 1F). This portion of the method 100 may catch all programs (probable viruses) that copy a local file to a remote file system and preserve the file name.

FIG. 2 is a block schematic diagram of an exemplary system 200 to protect a file system from a viral infection in accordance with an embodiment of the present invention. The file system protected may either a local file system or system memory 202 or a remote, shared or network file system 204, or both. Elements of the method 100 may be embodied in the system 200, such as in a file system protection program (FSPP) 206 associated with the local file system 202, FSPP 208 associated with the remote or shared file system 204 or FSPP 210 that may be associated with a network server or processor 212.

The system memory or local file system 202 may be a component of a computer system 214. The system memory 202 may include a read only memory (ROM) 216 and a random access memory (RAM) 218. The ROM 216 may include a basic input/output system (BIOS) 220. The BIOS 220 may contain basic routines that help to transfer information between elements or components of the computer system 214. The RAM 218 may contain an operating system 222 to control overall operation of the computer system 214. The RAM 218 may also include application programs 224, other program modules 226, and data and other files 228. The application programs 224 may include anti-virus software 230 and the file system protection program (FSPP) 206. The FSPP may be a stand alone application or may be a module in the operating system 222 or the anti-virus software 230. The FSPP 206 may include a rules table 232 to permit some file system operations, such as selected read and write operations, in response to predefined rules in the rules table.

The data and other files 226 may include a safe list 234 and a log 236. The safe list 234 may include a pre-loaded list of programs, such as File Explorer, a Visual screenbased editor (vi) and Editor MACros (emacs), or the like, that are safe to permit file system operations when called or required by any programs in the safe list. In one embodiment of the present invention, an administrator or user may be permitted to add or delete programs from the safe list 234.

The log 236 may be used to log or record flagged programs and alerts as discussed with respect to the method 100 of FIG. 1 when a program attempts a predetermined file system operation, or under at least one embodiment of the present invention, the program performs a permitted or approved file system operation as discussed with respect to method 100. In at least one embodiment of the present invention, all predetermined file system operations may be logged regardless of whether the program is on the safe list 234 or not. In another embodiment, only those programs that are not on the safe list and that are flagged may be logged. Logging the alert may include recording a file name and a memory or file location where the file is written by the flagged program or where the flagged program attempted to write the suspect file. The logging may also include recording any other information about the program, file, memory or file location where the file is written or similar information that may be helpful in later analysis or removing any virus and repairing any damage caused by the virus.

As previously discussed, the logged information associated an alert or flagged program may also be sent to a network monitoring system 238. The network monitoring system 238 may operate on a server or processor 212. The network monitoring system 238 may receive alerts from multiple computer systems, such as computer system 214. The network monitoring system 238 may analyze the alerts from multiple systems and identify an attack in progress when the network monitoring system 238 recognizes similar alerts from multiple computer systems. In this fashion, the system 200 may use the alerts for self-monitoring and to take corrective action and perform any needed changes or repairs to provide a self-healing system or network.

The computer system 214 may also include a processor or processing unit 240 to control operations of the other components of the computer system 214. The processing unit 240 may be coupled to the memory system 202 and other components of the computer system 214 by a system bus 242. The computer system 214 may also include a hard drive 244. The hard drive 244 may be coupled to the system bus 242 by a hard drive interface 246. The hard drive 244 may also form part of the local file system 202. Programs, software and data may be transferred and exchanged between the system memory 202 and the hard drive 246 for operation of the computer system 214.

The computer system 214 may also include multiple input devices, output devices or combination input/output devices 248. The input/output devices 248 may be coupled to the system bus 242 by an input/output interface 250. The input and output devices or combination I/O devices 248 permit a user to operate and interface with the computer system 214 and to control operation of the file system protection program 206. The I/O devices 248 may include a keyboard and pointing device to respond to alerts and approve file system operations. The I/O devices 248 also permit the safe list and rules table 232 to be modified. The I/O devices 248 may also include disk drives, optical, mechanical, magnetic, or infrared input/output devices, modems or the like. The I/O devices may be used to access a medium 252. The medium 252 may contain, store, communicate or transport computer-readable or computer executable instructions or other information for use by or in connection with a system, such as the computer system 214.

The computer system 214 may also include or be connected to a display or monitor 254. The monitor 254 may be coupled to the system bus 242 by a video adapter 256. The monitor 254 may be used to permit the user to interface with the computer system 214 and to present alerts to the user. In at least one embodiment of the present invention, the alerts presented to the user may include provisions for the user to approve the file system operation, such as writing or appending a file or the like, that is the subject of the alert by clicking on a radio button or the like in a graphical user interface associated with the alert with a pointing device or keyboard.

The computer system 214 may communicate with the remote, shared or network file system 204 via a network 258. The system bus 242 may be coupled to the network 248 by a network interface 260. The network interface 260 may be a modem, Ethernet card, router, gateway or the like for coupling to the network 258. The coupling may be a wired connection or wireless. The network 258 may be the Internet or private network, such as an intranet or the like. As previously described, the shared file system 204 may also include a file system protection program 208 or components of the FSPP to protect the remote, shared or network files 262 associated with the shared file system 204. The shared file system 204 may also include other programs 264 for operation of the shared file system 204.

The computer system 214 may also access the remote server or processor 212 via the network 258. As previously discussed, the remote server/processor 212 may include the network monitoring system 238 for analyzing alerts and information associated therewith and may also include components of the file system protection program 210.

Elements of the present invention, such as method 100 of FIGS. 1A-1H, and system 200 of FIG. 2, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in a medium for use by or in connection with a system, such as system 200 of FIG. 2. Examples of such a medium may be illustrated in FIG. 2 as network 258 or medium 252 and I/O devices 248. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method to protect a file system from a viral infection, comprising:
flagging a program in response to at least one of:
opening a local file on a local file system to perform a read operation and opening a shared file on a shared or network file system to perform a write or append operation with the local file;
the program reading or opening itself and the program attempting to write or append any content to the shared file on the shared or network file system or to write or append any content to the local file on the local file system;
the program attempting to write or append the local file to the shared or network file system and preserve a filename of the local file in the shared or network file system; and
the program attempting to write or append a remote file to the local file system.

2. The method of claim 1, further comprising inhibiting a write or append operation associated with program in response to flagging the program.

3. The method of claim 1, further comprising monitoring all file operations associated with the program in response to the program not being in a safe list.

4. The method of claim 1, further comprising permitting selected read and write operations in response to a predefined rules table.

5. The method of claim 1, further comprising sending an alert in response to flagging the program.

6. The method of claim 1, further comprising storing a filename and a location where the local or shared file is copied or written in response to the local or shared file being copied or written by the program.

7. The method of claim 1, further comprising sending an alert to a network monitoring system in response to flagging the program.

8. The method of claim 1, further comprising logging any file system operations including recording a filename and a location where the local or shared file is written.

9. A method to protect a file system from a viral infection, comprising:
monitoring predetermined file system operations associated with a program; and
logging any predetermined file system operations associated with the program including recording a filename and a location where a file is written.

10. The method of claim 9, further comprising selecting the program for monitoring in response to the program not being on a safe list.

11. The method of claim 10, further comprising logging any file system operations associated with any programs on the safe list.

12. The method of claim 9, further comprising receiving a notification that the program intends to perform one of the predetermined file system operations.

13. The method of claim 9, further comprising following a predefined procedure in response to a level of security set.

14. The method of claim 9, further comprising flagging the program in response to the program attempting to perform one of the predetermined file system operations.

15. The method of claim 14, further comprising flagging the program in response to at least one of:
the program opening a local file on a local file system to perform a read operation and opening a shared file on a shared or network file system to perform a write or append operation with the local file;
the program reading or opening itself and the program attempting to write or append any content to the shared file on the shared or network file system or to write or append any content to the local file on the local file system;
the program attempting to write or append the local file to the shared or network file system and preserve a filename of the local file in the shared or network file system; and
the program attempting to write or append a remote file to the local file system.

16. The method of claim 14, further comprising inhibiting any predetermined file system operations associated with the program in response to the program being flagged.

17. The method of claim 9, further comprising sending an alert in response to the program attempting to perform any predetermined file system operations.

18. The method of claim 17, further comprising sending the alert to a network monitoring system.

19. The method of claim 9, further comprising presenting an alert to a user for approval before the predetermined file system operation is performed by the program.

20. The method of claim 9, further comprising requiring approval before performing any predetermined file system operations associated the program in response to the program not being on a safe list.

21. A system to protect a file system from a viral infection, comprising:
a file system protection program including:
means to monitor predetermined file system operations associated with another program, and
means to log any predetermined file system operations associated with the other program including recording a filename and a location where a file is written.

22. The system of claim 21, further comprising a safe list, wherein the file system program is adapted to monitor the other program in response to the other program not being on the safe list.

23. The system of claim 21, further comprising a log to record any predetermined file system operations.

24. The system of claim 21, further comprising means to flag the other program in response to at least one of:
the other program opening a local file on a local file system to perform a read operation and opening a shared file on a shared or network file system to perform a write or append operation with the local file;
the other program reading or opening itself and the other program attempting to write or append itself or any content to the shared file on the shared or network file system or to write or append itself or any content to the local file on the local file system;
the other program attempting to write or append the local file to the shared or network file system and preserve a filename of the local file in the shared or network file system; and
the other program attempting to write or append a remote file to the local file system.

25. The system of claim 21, further comprising means to flag the other program in response to the other program attempting to perform one of the predetermined file system operations.

26. The system of claim 25, further comprising means to send an alert in response to flagging the other program.

27. The system of claim 25, further comprising:
a network monitoring system; and
means to send an alert to the network monitoring system in response to flagging the other program.

28. The system of claim 25, further comprising means to inhibit predetermined file system operations associated with the other program in response to the program other being flagged.

29. The system of claim 25, further comprising:
means to present an alert to a user; and
means for the user to approve the one of the predetermined file system operations before being performed by the other program.

30. A method of making system to protect a file system from a viral infection, comprising:
providing a file system protection program including:
providing means to monitor predetermined file system operations associated with another program, and
providing means to log any predetermined file system operations associated with the other program including recording a filename and a location where a file is written.

31. The method of claim 30, further comprising:
providing a safe list; and
adapting the file system protection program to monitor the other program in response to the other program not being on the safe list.

32. The method of claim 30, further comprising forming a log to record any predetermined file system operations.

33. The method of claim 30, further comprising providing means to flag the other program in response to at least one of:
the other program opening a local file on a local file system to perform a read operation and opening a shared file on a shared or network file system to perform a write or append operation with the local file;
the other program reading or opening itself and the other program attempting to write or append itself or any content to the shared file on the shared or network file system or to write or append itself or any content to the local file on the local file system;
the other program attempting to write or append the local file to the shared or network file system and preserve a filename of the local file in the shared or network file system; and
the other program attempting to write or append a remote file to the local file system.

34. The method of claim 30, further comprising providing means to flag the other program in response to the other program attempting to perform one of the predetermined file system operations.

35. The method of claim 34, further comprising providing means to send an alert in response to flagging the other program.

36. The method of claim 34, further comprising:
providing a network monitoring system; and
providing means to send an alert to the network monitoring system in response to flagging the other program.

37. The method of claim 34, further comprising:
providing means to present an alert to a user; and
providing means for the user to approve the one of the predetermined file system operations before being performed by the other program.

38. A computer-readable medium having computer-executable instructions for performing a method, comprising:
monitoring predetermined file system operations associated with a program; and
logging any predetermined file system operations associated with the program including recording a filename and a location where a file is written.

39. The computer-readable medium having computer executable instructions for performing the method of claim 38, further comprising selecting the program for monitoring in response to the program not being on a safe list.

40. The computer-readable medium having computer executable instructions for performing the method of claim 38, further comprising following a predefined procedure in response to a level of security set.

41. The computer-readable medium having computer executable instructions for performing the method of claim 38, further comprising flagging the program in response to the program attempting to perform one of the predetermined file system operations.

42. The computer-readable medium having computer executable instructions for performing the method of claim 41, further comprising flagging the program in response to at least one of:
the program opening a local file on a local file system to perform a read operation and opening a shared file on a shared or network file system to perform a write or append operation with the local file;
the program reading or opening itself and the program attempting to write or append itself or any content to the shared file on the shared or network file system or to write or append itself or any content to the local file on the local file system;
the program attempting to write or append the local file to the shared or network file system and preserve a filename of the local file in the shared or network file system; and
the program attempting to write or append a remote file to the local file system.

43. The computer-readable medium having computer executable instructions for performing the method of claim 41, further comprising inhibiting any predetermined file system operations associated with the program in response to the program being flagged.

44. The computer-readable medium having computer executable instructions for performing the method of claim 38, further comprising sending an alert in response to the program attempting to perform any predetermined file system operations.
